(19) United States
(12) Patent Application Publication
(10) Pub. No.: US 2011/0179002 A1
(43) Pub. Date: Jul. 21, 2011

(54) System and Method for a Vector-Space Search Engine

(75) Inventors: Aurelian Dumitru, Round Rock, TX (US); Jimmy Pike, Georgetown, TX (US)

(73) Assignee: DELL PRODUCTS L.P.

(21) Appl. No.: 12/689,855

(22) Filed: Jan. 19, 2010

(51) Int. Cl. G06F 17/30

(52) U.S. Cl. 707/706; 707/716; 707/E17.008; 707/E17.017

(57) ABSTRACT

A system and method for a search engine is disclosed. A method for operating a search engine may include calculating a plurality of document vectors, receiving a search request, calculating a search request vector, calculating a distance between the search request vector and the plurality of document vectors, and returning a list of documents that are within a predetermined distance of the search request vector. An information handling system for a search engine may include a central processing unit that is coupled to a general purpose graphical processing unit. The central processing unit is able to calculate a plurality of document vectors, receive a search request, calculate a search vector, and return a list of documents that are within a predetermined distance of the search request vector. The general purpose graphical processing unit is able to calculate a distance between the search request vector and the plurality of document vectors.

### TECHNICAL FIELD

The present disclosure relates generally to the operation of computer systems and information handling systems, and, more particularly, to a system and method for a vector-space search engine.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include a search engine. A search engine retrieves pages or content available over a network and makes the content searchable by a user. Over time, a number of different approaches to search algorithms have been used. Simple keyword searches of all of the documents stored in a database have given way to more complex pre-processing and indexing schemes. Commercially available search engines tend to rely on large databases to index and store documents needed by the search engine. As the size of searchable content has increased, so has the need for more and more processing power to maintain acceptable search performance.

### SUMMARY

In accordance with the present disclosure, a system and method for a search engine is disclosed. A method for operating a search engine may include calculating a plurality of document vectors, receiving a search request, calculating a search request vector, calculating a distance between the search request vector and the plurality of document vectors, and returning a list of documents that are within a predetermined distance of the search request vector. An information handling system for a search engine may include a central processing unit that is coupled to a general purpose graphical processing unit. The central processing unit is able to calculate a plurality of document vectors, receive a search request, calculate a search vector, and return a list of documents that are within a predetermined distance of the search request vector. The general purpose graphical processing unit is able to calculate a distance between the search request vector and the plurality of document vectors. Software for providing a search engine embodied in a computer-readable medium is also described. The software, when executed, is able to calculate a plurality of document vectors, receive a search request, calculate a search request vector, calculate a distance between the search request vector and the plurality of document vectors, and return a list of documents that are within a predetermined distance of the search request vector.

The system and method disclosed herein is technically advantageous because all searching of documents can be performed directly in memory, without a database, thus reducing delay caused by retrieving information from slower memory devices, such as hard disk drives. A second advantage of the system and method disclosed herein is that the vector representation inherently tends to group documents with similar content, thus giving the system and method an advantage over other approaches for locating documents with similar content. A third advantage of the system and method disclosed herein is that the use of boolean logic or regular expressions is not necessary, which improves the usability of the system and method. A fourth advantage of the system and method disclosed herein is that the vector-based approach implemented with general purpose graphical processing technology makes use of parallel processing power to efficiently search a large universe of documents. A fifth advantage of the system and method disclosed herein is that using general purpose graphical processing units to process search requests in part reduces the workload on the central processing unit and the system bus. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a flow diagram of a search engine implementing a reverse keyword index search algorithm.

FIG. 2 illustrates the operation of a vector-space search engine as disclosed herein.

FIG. 3 illustrates a method of calculating and storing document vectors in GPGPU cores.

FIG. 4 illustrates a method of searching using document vectors stored in GPGPU cores.

FIG. 5 illustrates an information handling system configured as a vector-space search engine.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. The information handling system may include one or more general purpose graphical processing units (GPGPUs). A general purpose graphical processing unit is a collection of processor cores that is able to perform mathematical operations in parallel, such as vector operations. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

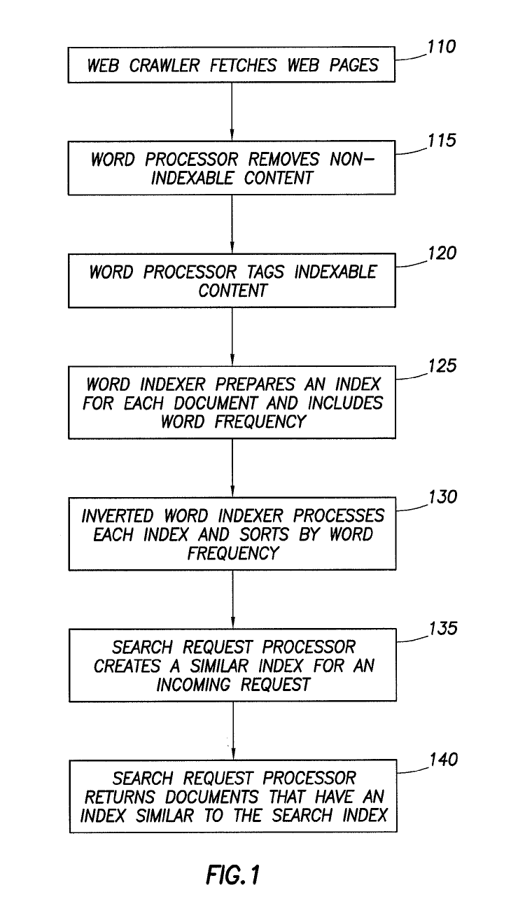

Shown in FIG. 1 is a simplified flow diagram of a search engine that implements a reverse keyword index search algorithm. At step 110, a web crawler fetches web pages from a target source. The target source may be a publicly available website, a private intranet, or extranet. The web crawler may be given a predetermined list of uniform resource locators (URLs) to determine which pages to fetch, or the web crawler may be given a starting URL, such as a homepage, and be programmed to recursively fetch pages linked from the starting URL. After fetching a page, the web crawler may store the fetched page and its associated content in a fetched page repository. The repository may be any type of file system or storage architecture, and is not limited to any particular type of database. The web crawler may store meta-data with the fetched page, such as the full URL of the page or the date it was retrieved.

At step 115, a word processor will load the fetched page from the repository. The word processor will remove all non-indexable content, such as hypertext markup language (HTML) tags or non-readable characters, from the page. At step 120, the word processor tags the indexable form of the fetched page with a unique document identifier. The tagged page is then stored in a repository which may be different from the fetched page repository. During step 125, a word indexer creates a word index, or forward word index, for the tagged page. The index for a tagged page includes all of the words that appear in the document and the frequency with which it occurs in the document. The index may be stored in a separate record, and is linked to the tagged page using the document identifier. Indexes are typically stored in a database management system. An inverted, or reversed, word index is created at step 130. The inverted word indexer retrieves the tagged document's forward word index and creates a new word index where the words are sorted by frequency in descending order. The inverted word index is then stored in a repository where it accessible to the search request processor.

When a search request is received, it is processed by the search request processor as shown at step 135. The incoming search request may be pre-processed to remove content from the request that is not indexable, such as special characters or non-readable characters. The search request processor then creates a reverse word index based on the search request. The search request processor compares the reverse word index based on the search request to the reverse word indexes stored in the search engine's repository. Documents whose reverse word indexes are the most similar to the search query's reverse word index are then returned to the user.

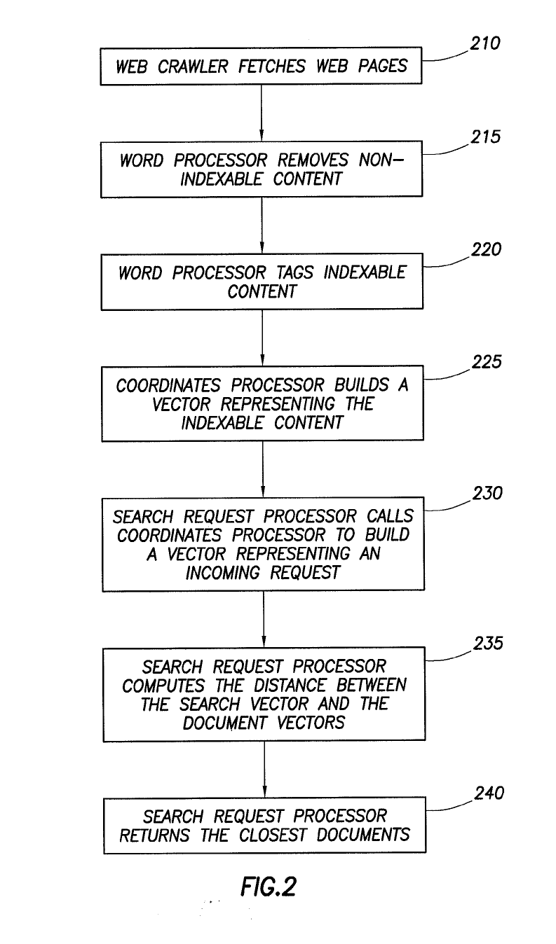

FIG. 2 illustrates the operation of a vector-space search engine as disclosed herein. At step 210, a web crawler fetches documents from a target. The target may be any source of indexable documents, such as a public website, a private intranet or extranet, a document management system, or even a file server. The web crawler may retrieve a predetermined set of documents, or be given a starting URL or UNC path with an instruction to recursively retrieve, or “crawl,” all the documents linked to the starting URL or UNC path. As the documents are retrieved, they may be stored in a repository for further processing on the same machine, or by a process running on a different machine. The repository may be a local file share, a database, a shared storage device, or a region of memory. Multiple instances of the web crawler may be operating at any given time. At step 215, a word processor removes non-indexable content from the document. Non-indexable content may include HTML tags, non-readable characters, formatting information, or “noise” words. At step 220, the indexable form of the retrieved document is tagged with a unique identifier and stored in a repository. The repository may be the same repository where retrieved documents are initially stored, or it may be a separate repository.

At step 225, the coordinates processor builds a vector representing the documents's indexable content in the term space. The term space is a multiple-dimensional space defined by a set of distinct words that may be used in a search request. This set of words may be referred to as a dictionary. Each document may be represented as a vector, or set of coordinates, in the term space. Each dictionary word that is present in the document may be a represented as component of the vector. The magnitude of a particular component may simply be the dictionary word's frequency in the document. The magnitude may also be a constant value. For example, the magnitude may be one if the dictionary word is present in the document, and the magnitude may be zero, if the dictionary word is absent from the document. In another embodiment, the magnitude of the component may be calculated using an algorithm that takes into account other contextual information, such as the font size of the word as it appears in the original document, or that the word is used as the anchor text for a hyperlink. The calculated vector will be associated with the document's unique identifier and may be stored in a repository, or in a general purpose graphical processing unit (GPGPU).

Step 230 occurs when a search request is received by the search handler. The search handler will use the dictionary to calculate a vector representation of the search request in the term space. The search handler may perform the calculation itself, or use the coordinates processor to create the vector. At step 235, the search handler computes the distance between the search request vector and the document vectors that were previously stored. If a document vector is within a certain distance of the search request vector, it is deemed a hit. Documents that are not hits but are within a second distance from the search request vector may be deemed a near hit.

In one embodiment, the search handler may use one or more GPGPU cores to calculate the distances between the vectors. If all of the document vectors are stored in one or more GPGPUs, then the calculation of the distance between the search request vector and the stored document vectors can be quickly computed in parallel by the multitude of processor cores typically found in a GPGPU. The search results can be compiled even more quickly using the GPGPU approach because all of the document vectors are already present in memory. This method of searching is advantageous because it eliminates the need to retrieve document vectors from slower memory devices, such as hard disk drives. Furthermore, the search engine is able to handle a larger volume of search requests because much of the computation is offloaded from the central processing unit to the GPGPU cores which can perform the calculations in parallel. Resource contention among the resources of an information handling system operating as a search engine is reduced because GPGPUs do not need to use the system bus to move data between processor cores while handling the search request.

Once all of the hits are determined and, optionally, all the near hits are determined, the search handler will return the search results to the user. The format of the search results may be a a listing of document identifiers, a listing of URLs or UNC paths, a stored copy of the documents, or any combination of information that may be desired by the user.

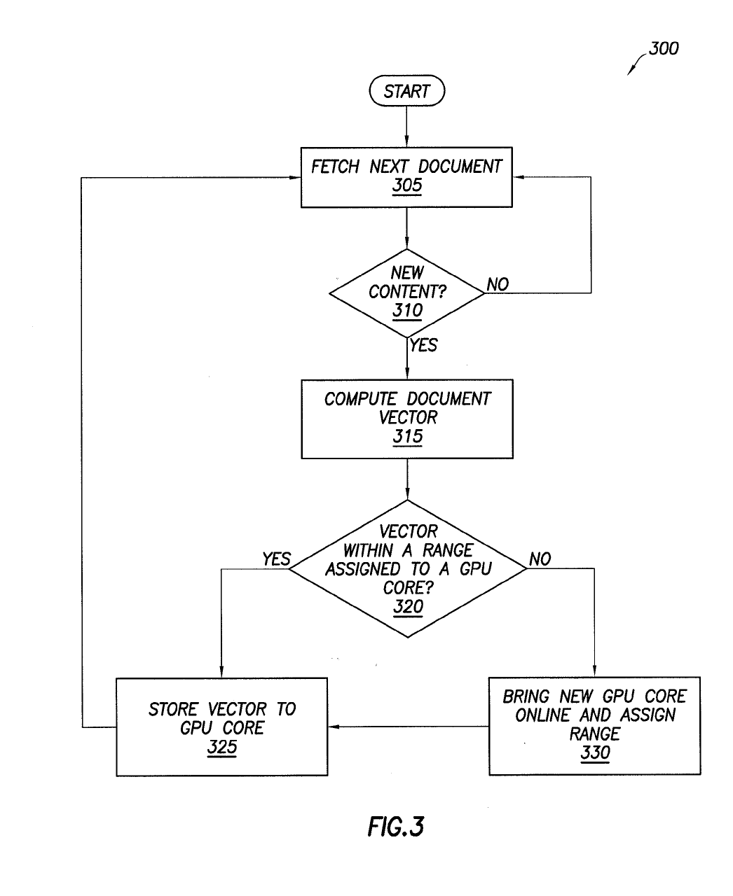

FIG. 3 illustrates a method of calculating and storing document vectors in the GPGPUs. The method starts at step 300. At 305, the system fetches the next document to be processed. The document may be retrieved from a live website using a web crawler, or may be retrieved from a repository of retrieved documents. At step 310, the system determines whether the document represents new content. This may be accomplished in any number of ways. In one implementation, the system may compare the document's URL or UNC path with the entries of a list or database of URLs or UNC paths that have been previously processed. Another implementation may compare the current document with the previously processed documents that are stored in a repository. If the document does not contain new content, then the document is ignored, and the system fetches another document waiting to be processed. If the document contains new content, the coordinates processor will calculate a vector representing the document in the term space at step 315. At step 320, the method determines which GPGPU core owns vectors similar to the new document vector. The method may use any number of criteria to assign ranges of the term space to various GPGPU cores. In one implementation, the criterion may be the distance between the new document's vector and a predetermined reference vector. The method uses the selected criterion to determine in which GPGPU core to place the new document vector at step 320. If the new document does not fall within a range already associated with a GPGPU core, then the method brings a new GPGPU core online, assigns the range to the GPGPU core, and stores the document vector in the core at step 330. If the document vector belongs to a range associated with an already existing GPGPU core, then the system stores the document vector in the associated GPGPU core at step 325. The method then returns to step 305 to process the next document.

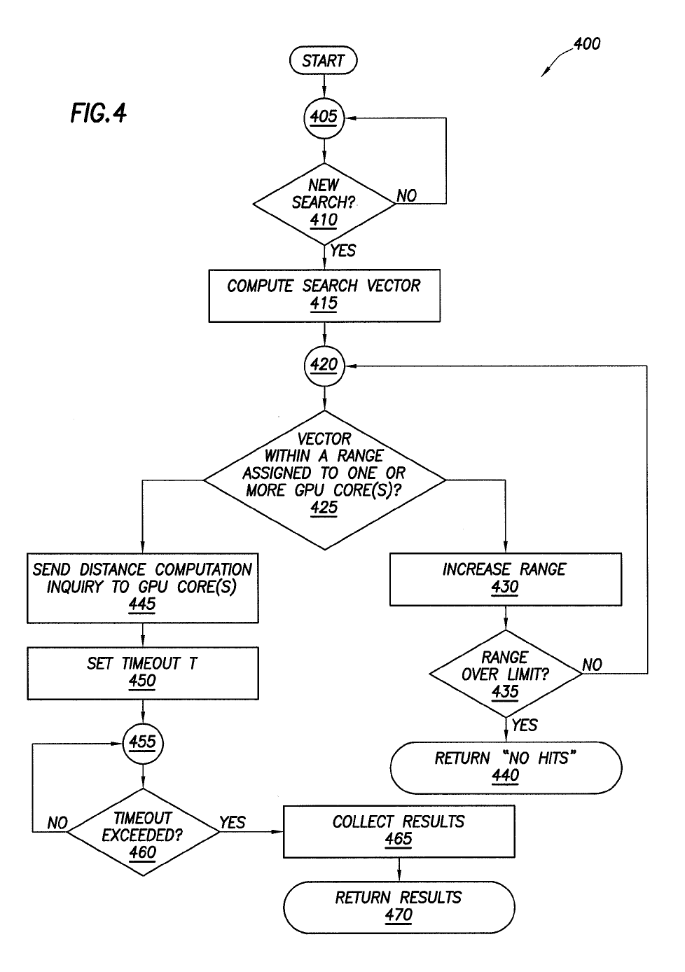

FIG. 4 illustrates a method of searching using document vectors stored in GPGPU cores. The method starts at step 400, and waits until a new search request is received at step 410. When a new search request is received, the search handler processes the search request at step 415, resulting in a vector representation of the search request. At step 425, the search handler determines whether the search vector is within a predetermined range of vectors associated with one of the GPGPU cores. If not, at step 430 the predetermined range is enlarged. At step 435, if the range would be outside a set range limit, then the method returns “no hits” at step 440. If the range is not outside the set range limit, then method continues to step 425. This loop continues until either the range limit is reached, or the search vector is within a range owned by a GPGPU core. If the search vector belongs to a range associated with a GPU core then, at step 445, the GPGPU core (or cores) is instructed to compute the distance between the document vectors stored in the GPGPU core and the search vector. For example, the GPGPU core may calculate the cosine between the search vector and each document vector stored in the particular core. As the cosine of the vectors approaches the value one, the closer the documents are to each other. When the value reaches a predetermined limit, it is deemed a hit. A lower threshold may be used to determine near hits. The search handler waits until a timeout is reached at step 460. At step 465, the search handler collects results from the one or more GPU cores instructed to calculate the distance between the vectors. If the calculated distance is within a predetermined range, the search handler classifies the document associated with the stored vector as a hit. If the calculated distance is within a second predetermined range that is larger than the first predetermined range, the search handler may classify the document as a near hit. At step 470, the search handler then returns the results in a format convenient to the user, such as a list of URLs and other information that describe the documents that are hits or near hits.

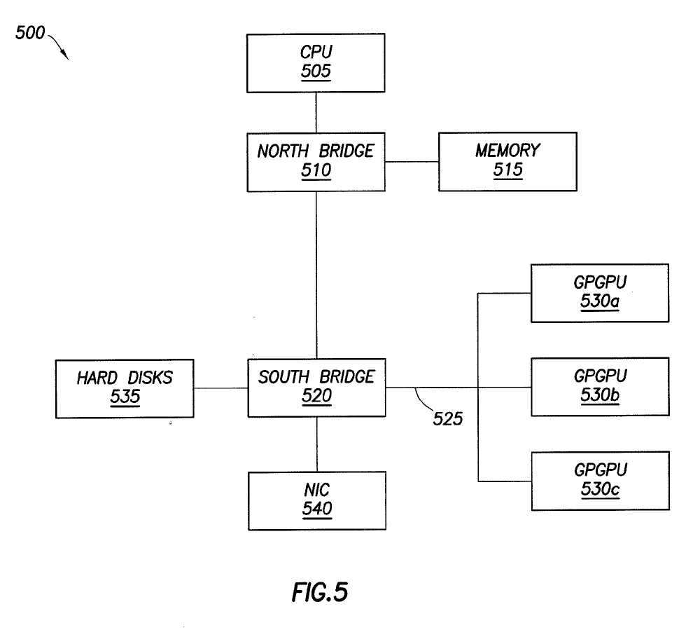

FIG. 5 illustrates an information handling system 500 configured as a vector-space search engine. Central processing unit (CPU) 505 is coupled to a north bridge 510. North bridge 510 couples memory 515 and south bridge 520 to the CPU 505. South bridge 520 provides connectivity between lower speed devices and the higher speed devices connected to the north bridge 510. Information handling system 500 may have hard disk drives 535 connected via a storage interface to the south bridge 520. A network interface controller (NIC) 540, coupled to the south bridge 520, provides connectivity to other information handling systems on a network. One or more GPGPU units 530a-530c may be coupled by way of an interface 525, such as a PCI Express, to the south bridge 520. GPGPUs 530a-530c may each contain several processor cores, with each core coupled to their own memory module. The size of the memory module coupled to a core determines how many document vectors may be stored in a particular core. An information handling system is not limited to the particular arrangement shown in FIG. 5. For example, the information handling system may have as few as one GPGPU, or many more GPGPUs than the three GPGPUs shown in FIG. 5, depending upon the particular limitations of the central processing unit and associated chip sets 510 and 520.

Although the present disclosure has been described in detail, it should be understood that various changes, substitutions, and alterations can be made hereto without departing from the spirit and the scope of the invention as defined by the appended claims.

What is claimed is:

1. A method for operating a search engine comprising:
calculating a plurality of document vectors;
receiving a search request;
calculating a search request vector;
calculating a distance between the search request vector and the plurality of document vectors; and
returning a list of documents that are within a predetermined distance of the search request vector.

2. The method of claim 1, wherein calculating the plurality of document vectors comprises:
retrieving a document;
calculating a document vector; and
storing the document vector in a general purpose graphical processing unit.

3. The method of claim 2, wherein storing the document vector in a general purpose graphical processing unit comprises determining which general purpose graphical processing unit is assigned to a range containing the document vector.

4. The method of claim 3, wherein determining which general purpose graphical processing unit is assigned to the range containing the document vector comprises calculating the distance between the document vector and a reference vector.

5. The method of claim 4, wherein the plurality of document vectors are stored in a memory coupled to the general purpose graphical processing unit.

6. The method of claim 1, wherein calculating the distance between the search request vector and the plurality of document vectors comprises:
determining whether the search request vector belongs to a range assigned to a general purpose graphical processing unit; and
calculating the distance between the search request vector and the plurality of document vectors stored in the general purpose graphical processing unit assigned to the range.

7. The method of claim 6, wherein calculating the distance between the search request vector and the plurality of document vectors comprises calculating a cosine.

8. An information handling system comprising:
a central processing unit coupled to a general purpose graphical processing unit;
wherein the central processing unit is operable to:
calculate a plurality of document vectors;
receive a search request;
calculate a search vector; and
return a list of documents that are within a predetermined distance of the search request vector; and
wherein the general purpose graphical processing unit is operable to calculate a distance between the search request vector and the plurality of document vectors.

9. The system of claim 8, wherein calculating the plurality of document vectors comprises:
retrieving a document;
calculating a document vector; and
storing the document vector in the general purpose graphical processing unit.

10. The system of claim 9, wherein the document vector is stored in the general purpose graphical processing unit assigned to the range containing the containing the document vector.

11. The system of claim 10, wherein determining the range that contains the document vector comprises calculating the distance between the document vector and a reference vector.

12. The system of claim 10 comprising:
a memory coupled to the general purpose graphical processing unit operable to store the plurality of document vectors.

13. The system of claim 8 wherein calculating the distance between the search request vector and the plurality of document vectors comprises:
determining whether the search request vector belongs to a range assigned to the general purpose graphical processing unit; and
calculating the distance between the search request vector and the plurality of document vectors stored in the general purpose graphical processing unit assigned to the range.

14. The system of claim 13 wherein calculating the distance between the search request vector and the plurality of document vectors comprises calculating a cosine.

15. Software for providing a search engine, the software being embodied in a computer-readable medium and when executed operable to:
calculate a plurality of document vectors;
receive a search request;
calculate a search request vector;
calculate a distance between the search request vector and the plurality of document vectors; and
return a list of documents that are within a predetermined distance of the search request vector.

16. The software of claim 15, wherein calculating the plurality of document vectors comprises:
retrieving a document;
calculating a document vector; and
storing the document vector in a general purpose graphical processing unit.

17. The software of claim 16, wherein storing the document vector in a general purpose graphical processing unit comprises determining which general purpose graphical processing unit is assigned to a range containing the document vector.

18. The software of claim 17, wherein determining which general purpose graphical processing unit is assigned to the range containing the document vector comprises calculating the distance between the document vector and a reference vector.

19. The software of claim 18, wherein the plurality of document vectors are stored in a memory coupled to the general purpose graphical processing unit.

20. The software of claim 15, wherein calculating the distance between the search request vector and the plurality of document vectors comprises:
determining whether the search request vector belongs to a range assigned to a general purpose graphical processing unit; and
calculating the distance between the search request vector and the plurality of document vectors stored in the general purpose graphical processing unit assigned to the range.
